(19) United States
(12) Patent Application Publication
(10) Pub. No.: US 2026/0339974 A1
(43) Pub. Date: Oct. 29, 2026

(54) Backwards Compatibility Features for Supporting ETL Solutions

(71) Applicant: Oracle International Corporation, Redwood Shores, CA (US)

(72) Inventor: Michael Sassin, Andover, MA (US)

(73) Assignee: Oracle International Corporation, Redwood Shores, CA (US)

(21) Appl. No.: 19/192,941

(22) Filed: Apr. 29, 2025

(51) Int. Cl. G06F 16/25; G06F 16/21

(52) U.S. Cl. CPC G06F 16/254; G06F 16/212

(57) ABSTRACT

Techniques for executing ETL solutions on older versions of database schema are disclosed. Initially, the system accesses a first dataset having a first version of a database schema from an operational database and an ETL solution for transforming a second dataset having a second version of the database schema into third dataset having a target schema. The second version of the database schema is backwards compatible with the first version of the database schema. The system determines the differences between the first version of the database schema and the second version of the database schema and accesses instructions for responding to the differences. The system executes the ETL solution to generate the third dataset having the target schema. Executing the ETL solution may include applying the instructions for responding to the differences or generating the second dataset using the instructions and applying the ETL solution to the second dataset.

### TECHNICAL FIELD

The present disclosure relates to extract transform load (ETL) solutions. In particular, the present disclosure relates to backwards compatibility features for supporting ETL solutions.

### BACKGROUND

Operational databases are systems designed to manage day-to-day transactional data for an organization, supporting applications like customer relationship management (CRM), enterprise resource planning (ERP), and e-commerce platforms. Operational databases typically use a normalized schema to optimize storage efficiency and ensure data consistency. Newer versions of a database schema may include additional columns and/or tables that were not included in older versions of the database schema. Business integration (BI) logic uses ETL solutions to transfers data from operational databases for downstream processing. The ETL solutions typically are created using a latest version of a database schema.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIGS. 2A and 2B illustrate an example set of operations for executing ETL solutions on older versions of database schema in accordance with one or more embodiments;

FIG. 3A illustrates metadata tables representing a first version of a database schema;

FIG. 3B illustrates metadata tables representing a second version of the database schema;

FIG. 3C illustrates default behaviors for addressing difference between the first and second versions of database schema of FIGS. 3A and 3B, respectively; and

FIG. 4 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. ETL SOLUTION COMPATABILITY SYSTEM ARCHITECTURE
3. EXECUTING ETL SOLUTIONS ON OLDER VERSIONS OF DATABASE SCHEMA
4. EXAMPLE DATABASE SCHEMA VERSION DIFFERENCES AND DEFAULT BEHAVIORS
5. PRACTICAL APPLICATIONS, ADVANTAGES & IMPROVEMENTS
6. HARDWARE OVERVIEW
7. MISCELLANEOUS; EXTENSIONS

### 1. General Overview

One or more embodiments support ETL solutions on older versions of database schema for graceful degradation of the ETL solutions. ETL solutions generally reflect a current version of a database schema, also referred to herein as staging schema. Older version of a database schema may be missing columns and/or tables or have columns of different types. Applying an ETL solution to an older version of a database schema will result in an error when a column or table is queried that does not exist in the older version of the database schema. Encountering such an error results in failure of the ETL solution.

One or more embodiments identify the differences between the versions of database schema and addresses the differences. The system may, for example, create a column with default values in the staging schema. The system applies the ETL solution to the dataset in the staging schema to generate the target schema. Alternatively, the system may provide instructions for use during application of the ETL solution to create the missing columns and/or tables as data is replicated and loaded into a target schema.

One or more embodiments identify the missing data in the source schema by comparing metadata of the source schema to metadata of the staging schema. Alternatively, the system identifies the missing data by querying the dataset of the source schema for the columns and/or tables required for executing the ETL solution. When the query fails to return a column and/or a table, the system identifies that column and/or table as missing. The ETL solution may be updated to include the instructions for creating the missing columns and/or tables.

One or more embodiments described in this Specification and/or recited in the claims may not be included in this General Overview section.

### 2. Compatability Engine System Architecture

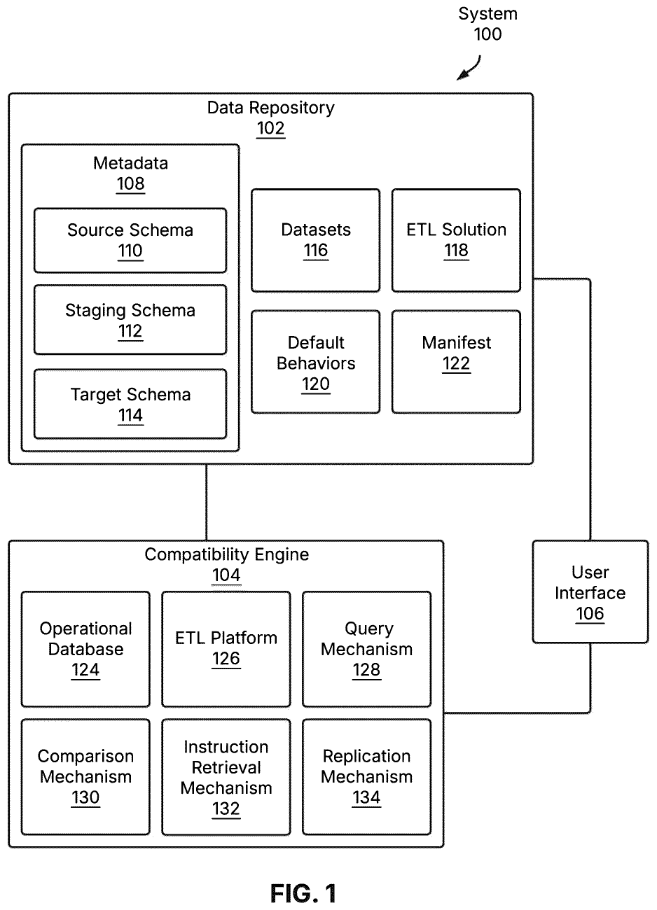

FIG. 1 illustrates a system 100 in accordance with one or more embodiments. As illustrated in FIG. 1, system 100 includes data repository 102, compatibility engine 104, and user interface 106. In one or more embodiments, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

In one or more embodiments, a data repository 102 is any type of storage unit and/or device (e.g., a file system, database, collection of tables, or any other storage mechanism) for storing data. Further, a data repository 102 may include multiple different storage units and/or devices. The multiple different storage units and/or devices may or may not be of the same type or located at the same physical site. Further, a data repository 102 may be implemented or executed on the same computing system as compatibility engine 104. Additionally, or alternatively, a data repository 102 may be implemented or executed on a computing system separate from compatibility engine 104. The data repository 102 may be communicatively coupled to compatibility engine 104 via a direct connection or via a network.

Information describing compatibility engine 104 may be implemented across any components within the system 100. However, this information is illustrated within the data repository 102 for purposes of clarity and explanation.

In one or more embodiments, data repository 102 includes metadata 108, datasets 116, ETL solution 118, default behaviors 120, and manifest 122.

In one or more embodiments, metadata 108 refers to the data that describes the structure of a database. Metadata 108 may include details about the tables, columns, data types, constraints, relationships, and other components that define how data is organized and managed within the database. Metadata 108 may include the names of all tables and views in the database, purposes of the tables, and how the tables relate to one another. For each table and view, metadata 108 may describe each column's name, data type, e.g., integer, varchar, date, default values if any, and whether null values are allowed. Constraints may include primary keys and foreign keys. Metadata 108 may include index names, the columns the indexes covers, and the types of indexes, e.g., unique, non-unique, clustered, non-clustered.

In one or more embodiments, metadata 108 represents source schema 110, staging schema 112, and/or target schema 114. Source schema 110, staging schema 112, and target schema 114 refer to configurations of data at different parts of a data pipeline architecture.

In one or more embodiments, source schema 110 refers to a structure of data as the data exists in an operational database 124. Source schema 110 includes the organization of the data tables, views, indexes, and relationships as data tables, views, indexes, and relationships are defined in the operational database 124. Source schema 110 may be optimized for transactional processing, i.e., highly normalized. Columns and/or tables present in a latest or current version of the database schema may be missing from source schema 110. Column types of the latest version of the database schema may be different from column types of source schema 110. There may be many versions of the database schema between source schema 110 and the latest version of the database schema.

In one or more embodiments, staging schema 112 refers to a structure of data in a database as the data is expected to exist. Staging schema 112 may represent a latest version of a database schema. Staging schema 112 is used to generate an ETL solution. Staging schema 112 may include columns and/or tables that are not present in source schema 110. Staging schema 112 may include column types that are different from source schema 110.

In one or more embodiments, target schema 114 refers to a structure of data in a data warehouse or a data mart. Target schema 114 represents a structure of data subsequent to ETL operations. Target schema 114 is a structure of data for downstream applications. Target schema 114 may be optimized for query and analysis, i.e., denormalized or organized in dimensional models, e.g., like star schemas and snowflake schemas.

In one or more embodiments, datasets 116 refer to (a) data maintained in operational database 124, (b) data reflecting a latest version of a database schema, i.e., staging schema, and (c) data from operational database that has undergone ETL operations. Datasets 116 maintained in operational database 124 have a first version of a database schema, i.e., source schema 110. Datasets 116 that have undergone ETL operations have target schema 114.

In one or more embodiments, ETL solution 118 refers to a combination of processes, tools, and methodologies used to execute the extract, transform, and load phases of a data integration process. ETL solutions 118 prepare data for business intelligence, reporting, data warehousing, and data migration projects. The extract phase of ETL solution 118 may include pulling, or extracting, data from operational database 124. In the extract phase, the extracted data is cleansed, enriched, converted, and formatted to meet the business requirements of the target system or data warehouse. Transformations may include cleansing the extracted data to remove inaccuracies or duplicates, normalization or denormalization depending on a target schema, joining data from multiple sources, aggregating data for analytical needs, calculating new values based on business logic. The load phase is where the transformed data is loaded into the target database, data warehouse, or another storage system. The loading can be done in batches (batch loading) or in real-time (streaming load) depending on the requirements.

In one or more embodiments, ETL solution 118 includes metadata representing a version of a database schema used for generating the solution. ETL solution 118 may include a metadata repository that includes information about the data sources used to generate the ETL solution 118. The version of the database schema used for generating the solution may differ from the version of the database schema of operational database 124, i.e., source schema.

In one or more embodiments, default behaviors 120 refer to instructions for handling missing source data, i.e., columns, tables. When a column is missing, a default behavior may include setting a default value for the column. For a column that includes a number, the default value may be “0”. A default behavior for a missing table may include creating an empty placeholder table. The placeholder table may have the same structure of the expected table but contains no real data, or only default or dummy data to fulfill foreign key constraints or similar dependencies.

In one or more embodiments, default behaviors 120 include a function for handling a missing column, e.g.,
IFEXISTS (SRC_TABLE.SRC_COLUMN, <default>) DATATYPE VARCHAR(20).

The function returns a value of the source table column when the column exists and a default value, i.e., <default> when the column does not exist. The behavior is similar to NVL(COLUMN, <default>) that returns <default> when a NULL value is encountered. The system may require a column data type when the schema does not contain the referenced source column.

In one or more embodiments, default behaviors 120 include a function for handling a missing table, e.g.,

IMPORT SOURCE NEW_TABLE
IFMISSING
[
THIS[COL1] = NULL − DATATYPE VARCHAR2(1);
THIS[COL2] = NULL − DATATYPE DATE;
...
THIS[COL9] = ...;
THIS[COL10] = ‘−‘

In one or more embodiments, manifest 122 refers to a document or file that includes instructions for handling differences between different versions of source schema. Manifest 122 may include instructions for creating a table when a table is missing from the source schema, for creating a column when a table is missing from the source schema, and/or updating a column type when a column type is different in the source schema. Manifest 122 may include a configuration file.

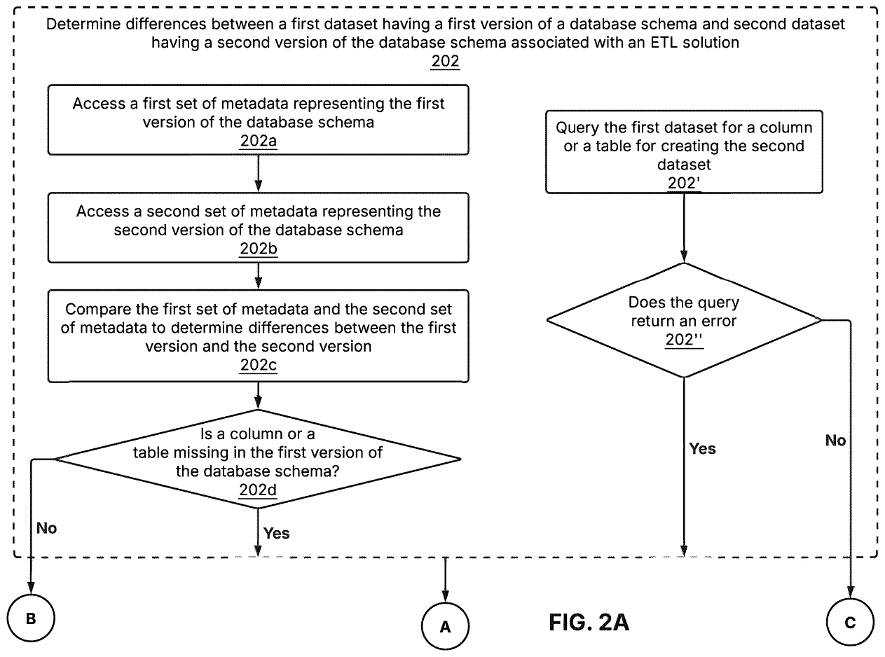

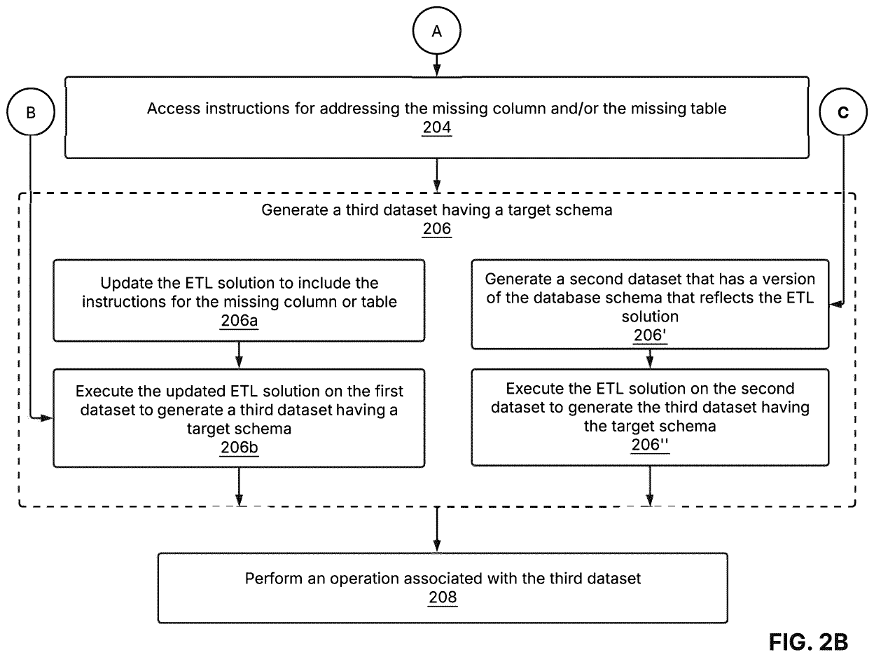

In one or more embodiments, compatibility engine 104 refers to hardware and/or software configured to perform operations described herein for executing ETL solutions on older versions of source schema. Examples of operations for executing ETL solutions on older versions of source schema are described below with reference to FIGS. 2A and 2B.

In an embodiment, compatibility engine 104 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

In one or more embodiments, compatibility engine 104 includes operational database 124. Operational database 124 may be a type of database optimized for managing and storing real-time transactional data for day-to-day business operations. Operational database 124 may be designed to handle real-time updates and queries for transactional data. Data in operational database 124 is stored in a normalized structure to reduce redundancy and ensure data consistency. Tables in operational database 124 may be related using foreign keys, enabling efficient updates and inserts.

In one or more embodiments, compatibility engine 104 includes an ETL platform 126. ETL platform 126 refers to hardware and/or software configured to perform operations described herein for collecting data from a database, transforming the data into a suitable format, and loading the data into a target data store. ETL platform 126 is configured to execute ETL solution 118.

In one or more embodiments, compatibility engine 104 includes a query mechanism 128. Query mechanism 128 refers to hardware and/or software configured to perform operations described herein for extracting data from operational database 124. Query mechanism 128 may be a component of ETL platform 126.

In one or more embodiments, compatibility engine 104 includes a comparison mechanism 128. Comparison mechanism 128 refers to hardware and/or software configured to perform operations described herein for identifying differences between source schema 110 and staging schema 112. Comparison mechanism 128 may compare metadata for each of the schemas. Comparison mechanism 128 may identify columns or tables present in staging schema 112 that are missing in source schema 110. Comparison mechanism 128 may also identify changes in column types between source schema 110 and staging schema 112.

In one or more embodiments, compatibility engine 104 includes an instruction retrieval mechanism 130. Instruction retrieval mechanism 130 refers to hardware and/or software configured to perform operations described herein for retrieving instructions from a manifest or configuration file for addressing differences between source schema 110 and staging schema 112. Instructions retrieved by the instruction retrieval mechanism 130 may include creating columns and/or tables when columns and/or tables in staging schema 112 are missing from source schema 110.

In one or more embodiments, compatibility engine 104 includes a replication mechanism 134. Replication mechanism 134 refers to hardware and/or software configured to perform operations described herein for transferring data from operational database 124 to a target data lake or data warehouse. Replication mechanism 134 may replicate data from a source system to a staging area or directly to the data warehouse. Replication mechanism 134 may operate in real-time, i.e., streaming replication, or at scheduled intervals.

In one or more embodiments, user interface 106 refers to hardware and/or software configured to facilitate communications between a user and compatibility engine 104. User interface 106 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of user interface 106 are specified in different languages. The behavior of user interface elements is specified in a dynamic programming language, such as JavaScript. The content of user interface elements is specified in a markup language, such as hypertext markup language (HTML) or XML User Interface Language (XUL). The layout of user interface elements is specified in a style sheet language, such as Cascading Style Sheets (CSS). Alternatively, user interface 106 is specified in one or more other languages, such as Java, C, or C++.

### 3. Executing ETL Solutions on Older Versions of Database Schema

FIGS. 2A and 2B illustrate an example set of operations for executing ETL solutions on older versions of database schema in accordance with one or more embodiments. One or more operations illustrated in FIGS. 2A and 2B may be modified, rearranged, or omitted all together. Accordingly, the particular sequence of operations illustrated in FIG. 2A or 2B should not be construed as limiting the scope of one or more embodiments.

One or more embodiments determine differences between a first dataset having a first version of a database schema and second dataset having a second version of the database schema associated with an ETL solution (Operation 202). The first dataset is maintained in an operational database that has the first version of the database schema. The second version of the database schema is one or more versions newer than the first version of the database schema. The second version of the database schema includes columns and tables that are not included in the first version of the database schema. The second version of the database schema reflects the version of the database schema used to generate the ETL solution.

In one or more embodiments, the system determines differences between the first version of the database schema and the second version of the database schema using metadata of the first and second versions of the database schema. Operations for determining the differences between the versions of the database schema using metadata of the database schema are described below with reference to Operations 202a-202d.

One or more embodiments access a first set of metadata representing the first version of the database schema (Operation 202a). The first set of metadata is stored in a manner that is accessible and manageable. The storage can be a part of the database itself, e.g., system tables in structured query language (SQL) databases, or an external metadata repository specifically designed to hold schema versions and other relevant details.

In one or more embodiments, the system uses internal version control mechanisms within the database or integrates with external tools like Liquibase, Flyway, or custom version control systems. For relational database systems (RDBMS), e.g., PostgreSQL, MySQL, Oracle, SQL Server, the system retrieves metadata using SQL queries against system catalogs or information schema views. Each RDBMS has its own set of system tables and views. These queries retrieve details about columns and/or tables, such as data types, default values, and nullability. Many databases come with built-in tools and utilities that facilitate metadata retrieval. For example, pgAdmin for PostgreSQL, provides a graphical interface to browse database objects and view their properties; MySQL Workbench for MySQL allows users to inspect schema details through a user-friendly interface; Oracle SQL Developer for Oracle offers comprehensive tools for accessing and managing database metadata; and SQL Server Management Studio (SSMS) for SQL Server enables users to explore object properties and configurations visually.

In one or more embodiments, the system uses command-line tools provided by database systems to retrieve metadata. The system may use programming libraries and application programming interfaces (APIs) specific to different programming languages used to interact with databases and retrieve metadata programmatically. For example, in Python, the system uses libraries such as SQLAlchemy or Psycopg2 for PostgreSQL, PyMySQL for MySQL to execute SQL commands and fetch metadata. In Java, JDBC provides methods to retrieve database metadata. The system may use dedicated metadata management systems, e.g., Apache Atlas, Collibra, or Informatica's Enterprise Data Catalog. Metadata management systems provide advanced capabilities for metadata aggregation, search, governance, and lineage tracking. The system may use ETL tools, e.g., Talend, Informatica. ETL tools may provide built-in mechanisms to explore and extract metadata from connected data sources. ETL tools may use a combination of the methods mentioned above, abstracted behind a graphical interface for ease of use.

One or more embodiments access a second set of metadata representing the second version of the database schema (Operation 202b). The second set of metadata may be provided with the ETL solution. ETL tools may maintain a metadata repository including the second set of metadata. Accessing the second set of metadata may include querying the metadata repository maintained by the ETL tools. The system may use custom scripts or APIs to access the metadata.

One or more embodiments compare the first set of metadata and the second set of metadata to determine differences between the first version and the second version (Operation 202c). The system may export the first and second sets of metadata into a format that can easily be compared. This may include using spreadsheets or a database table specifically for comparing metadata from different versions of database schema. The system may use tools or scripts to compare the metadata from the two versions. When using spreadsheets, the system may use built-in comparison functions or conditional formatting to highlight differences. The system may use database queries to identify differences. Alternatively, the system may use database schema comparison tools to automatically compare the metadata.

One or more embodiments determine that a column or a table is missing in the first version of the database schema (Operation 202d). Based on the comparison, the system identifies tables and/or columns in the second set of metadata that are missing in the first set of metadata. The comparison of the first set of metadata and the second set of metadata may identify changes in data types, constraints and/or indexes between the first dataset and the second dataset.

In one or more embodiments, the system determines differences between the first version of the database schema and the second version of the database schema by making queries of the first dataset. Operations for determining the differences between the versions of the database schema by making queries of the first dataset are described below with reference to Operations 202′-202″.

One or more embodiments query the first dataset for a column or a table for creating the second dataset (Operation 202′). The system may access the data from the operational database using queries, e.g., SQL queries. The system may generate the queries based on data required for executing the ETL solution. The system may use ETL tools to extract the data from the operational database. The system may use API calls to check for the existence of a column or table.

One or more embodiments receive an error in response to the query (Operation 202″). In response to not being able to find the queried column and/or table in the first dataset, the system may return an error. An error in response to a query for a column or a table is an indication that that table does not exist.

One or more embodiments access instructions for addressing the missing column and/or the missing table (Operation 204). When a column and/or table is determined to be missing from the first version of the database schema, the system may consult a configuration file or manifest to address the missing column and/or table. The configuration file may include default behaviors for responding to the missing table or to the missing column or to a changed column type. The default behaviors may include instructions for creating an empty table in response to a missing table or creating an empty column in response to a missing column. The default behaviors may include default values for including in the created tables or columns. Some of the tables in the ETL solution or in a real-time stream analytics solution may be constructed on the fly in in-memory data structure, or, in the case of LoCode, in a Parquet file structure.

One or more embodiments generate a third dataset having a target schema (Operation 206). The system address the differences between the first version of database schema and the second version of the database schema, i.e., missing columns, missing tables, changed column type. Once addressed, the system executes the ETL solution to generate the third dataset.

In one or more embodiments, the system generates the third dataset by updating the ETL solution to include instructions for addressing the missing columns and/or tables. Operations for generating the third dataset using an updated ETL solution are described below with reference to Operations 206a-206b.

One or more embodiments update the ETL solution to include the instructions for the missing column or table (Operation 206a). The system may update the ETL solution to include the instructions for responding to the missing column and/or missing table or for addressing changes in column types between the first dataset and the second dataset. By updating the ETL solution to include the instructions for responding to the missing columns and/or tables, the system may perform the ETL solution using the first dataset without failing or halting.

One or more embodiments execute the updated ETL solution on the first dataset to generate a third dataset having a target schema (Operation 206b). The system executes the updated ETL solution on the first dataset. Since the updated ETL solution includes instructions for handling the column and/or the table missing from the first dataset, e.g., creating an empty table, executing the updated ETL solution on the first dataset generates the third dataset having the target schema. In an embodiment, the ETL solution denormalize the first dataset to create a denormalized third data set.

In one or more embodiments, the system generates the third dataset by generating a second dataset that addresses the missing column and/or the missing table and executes the ETL solution on the second dataset. Operations for generating the third dataset by applying the ETL solution to second dataset are described below with reference to Operations 206′-206″.

One or more embodiments generate a second dataset that has a version of the database schema that reflects the ETL solution (Operation 206′). The version of the database schema that reflects the ETL solution, i.e., staging schema, includes the missing column or table. Using various ETL tools, the system executes the instructions for address the missing column or table when importing the first dataset to generate the second dataset. In this manner, the second dataset includes the missing column or table.

One or more embodiments execute the ETL solution on the second dataset to generate the third dataset having the target schema (Operation 206″). Since the second dataset includes the missing column or table, executing the ETL solution on the second dataset will not return an error in response to the missing column or table because the column or table is not missing in the second dataset. Any degradation in the resulting target schema is graceful and limited.

In one or more embodiments, the system dynamically captures metadata at runtime for the source schema and determines, at runtime, if the reference column and/or table exists when referring to replication or routing instructions. The system may issue an error if the particular column or table does not exist in the source system. The system may execute the IFEXISTS( . . . ) function to handle missing column and/or table, i.e., define a default behavior and populate a standardized target schema. The system may use this feature for streaming analytics that create in-memory representations of the data.

One or more embodiments perform an operation associated with the third dataset (Operation 208). The system may use the third dataset that is generated by execution of the ETL solution or updated ETL solution to perform various operations. The operations may include executing a query on the third dataset, populating one or more dashboards, and creating one or more charts, graphs, and/or maps to visually communicate insights. The system may use the third dataset to support business operations, e.g., inventory management, demand forecasting, and/or customer relationship management.

### 4. Example Database Schema Version Differences and Default Behaviors

A detailed example is described below for purposes of clarity. Components and/or operations described below should be understood as one specific example which may not be applicable to certain embodiments. Accordingly, components and/or operations described below should not be construed as limiting the scope of any of the claims.

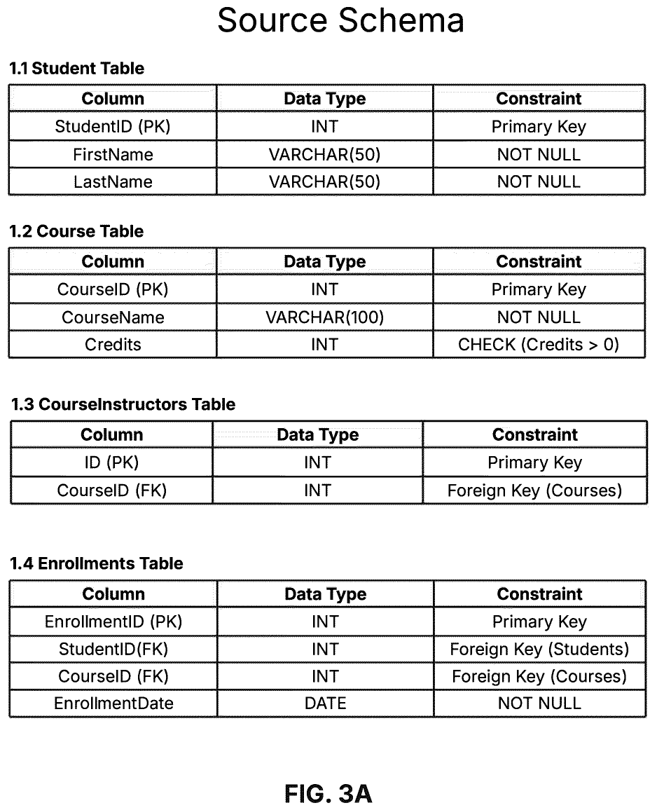

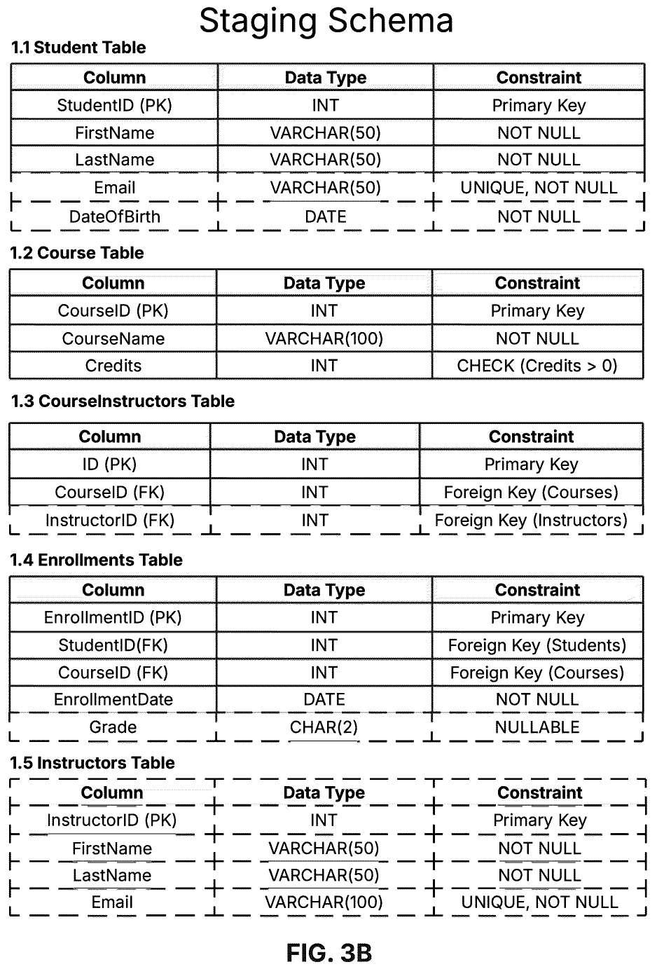

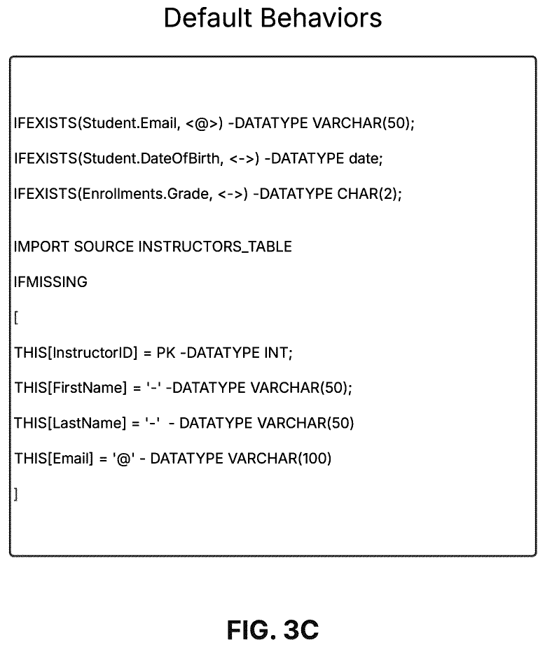

FIG. 3A illustrates tables representing metadata for data in an operational database having a first version of a database schema, i.e., source schema. As shown, the database includes a 4 tables, Student Table, a Course Table, a CourseInstructors Table, and an Enrollment Table. Each of the first two tables includes three (3) columns, the third table includes two (2) columns, and the fourth table includes four (4) columns.

FIG. 3B illustrates tables representing metadata for a second version of the database schema, i.e., staging schema. As shown, the second version of the database schema includes columns and tables that are not present in the first version of the database schema. The missing columns and tables are indicated by the dashed lines. In particular, the second version of the database schema includes an additional table, i.e., Course Table with four (4) rows, two additional columns in Student Table and an additional column in the Enrollment Table.

The differences between the first version of the database schema and the second version of the database schema may be identified by comparing the metadata for the two versions of the database schema.

FIG. 3C illustrates default behaviors for responding to differences between the source schema and the staging schema. The default behaviors employ IF EXISTS and IF MISSING operations to address the columns and table missing in the source schema.

### 5. Practical Applications, Advantages & Improvements

ETL solutions that can handle multiple source versions of a database schema is highly beneficial, particularly in environments where data sources evolve over time due to changes in business requirements, and technology upgrades.

Practical applications may include data migration and integration projects, business intelligence and analytics, and software as a service (Saas) providers. Frequently, businesses undergo data migration from legacy systems to newer platforms or need to integrate data from multiple sources that may not be using the same schema version. An ETL solution capable of handling multiple source versions simplifies this process significantly. For (SaaS) providers serving multiple clients with different versions of the same application (and underlying databases), a multi-version ETL system can streamline data operations across clients.

Advantages may include flexibility and scalability, reduced complexity, error reduction, improved data quality, and cost efficiency. The ability to handle multiple schema versions makes the ETL process flexible and scalable, accommodating new data sources and schema updates without extensive reconfiguration. By managing different schema versions within a single ETL tool, complexity is reduced, eliminating the need for multiple data pipelines or extensive manual interventions. Automated handling of different schemas decreases the likelihood of errors that can occur when manually configuring ETL processes for new or updated schemas. Consistent and correct data transformation, despite variations in source schemas, leads to improved data quality and reliability in downstream applications. Reducing the need for multiple tools or custom solutions for each schema version can lead to significant cost savings in terms of both development and maintenance.

### 6. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

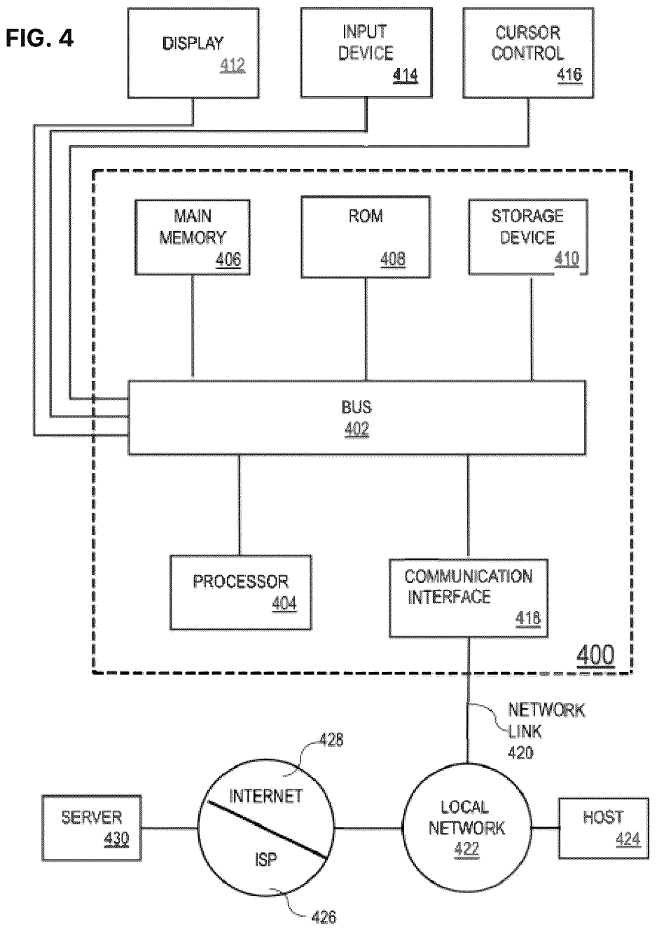

For example, FIG. 4 is a block diagram that illustrates a computer system 400 upon which an embodiment of the disclosure may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or a Solid State Drive (SSD) is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### 7. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected, and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

1. One or more non-transitory computer readable media comprising instructions which, when executed by one or more hardware processors, cause performance of operations comprising:
accessing, from an operational database, a first dataset having a first version of a database schema;
accessing an extract transform load (ETL) solution for transforming a second dataset having a second version of the database schema into third dataset having a target schema, wherein the second version of the database schema is backwards compatible with the first version of the database schema;
determining differences between the first version of the database schema and the second version of the database schema;
accessing instructions for responding to the differences between the first version of the database schema and the second version of the database schema; and
subsequent to accessing the instructions for responding to the differences between the first version and the second version of the database schema, executing the ETL solution to generate the third dataset having the target schema, wherein executing the ETL solution comprises one of:
a. applying the instructions for responding to the differences between the first version of the database schema and the second version the database schema to the first dataset; or
b. i. generating the second dataset using the instructions for responding to the differences between the first version of the database schema and the second version of the database schema, and
ii. applying the ETL solution to the second dataset.

2. The one or more non-transitory computer readable media of claim 1, wherein the operations further comprise:
executing an operation using the third dataset.

3. The one or more non-transitory computer readable media of claim 1, wherein determining the differences between the first version of the database schema and the second version of the database schema comprises:
accessing a first set of metadata representing the first version of the database schema;
accessing a second set of metadata representing the second version of the database schema; and
comparing the first set of metadata and the second set of metadata to identify one or more differences between the first dataset and the second dataset.

4. The one or more non-transitory computer readable media of claim 1, wherein determining the differences between the first version of the database schema and the second version of the database schema comprises at least one of:
i. identifying one or more columns in the second version of the database schema that is missing in the first version of the database schema;
ii. identifying one or more tables in the second version of the database schema that is missing in the first version of the database schema; or
iii. identifying one or more column types in the second version of the database schema that are different from one or more column types in the first version of the database schema.

5. The one or more non-transitory computer readable media of claim 1, wherein the instructions for responding to the differences between the first version of the database schema and the second version of the database schema comprises at least one of:
i. instructions for creating one or more missing columns;
ii. instructions for creating one or more missing tables; or
iii. instructions for changing a column type.

6. The one or more non-transitory computer readable media of claim 1, wherein determining the differences between the first version of the database schema and the second version of the database schema comprises:
querying the first dataset for a column or a table;
receiving an error message in response to querying the first dataset for the column or the table; and
responsive to receiving the error message, identifying the column or the table as a missing column or table.

7. The one or more non-transitory computer readable media of claim 1, wherein the target schema is amended to hide missing data.

8. The one or more non-transitory computer readable media of claim 1, wherein accessing instructions for responding to the differences between the first version of the database schema and the second version of the database schema comprises:
checking a manifest for default behaviors for responding to the differences; and
generating the instructions for responding to the differences.

9. A method comprising:
accessing, from an operation database, a first dataset having a first version of a database schema;
accessing an ETL solution for transforming a second dataset having a second version of the database schema into third dataset having a target schema, wherein the second version of the database schema is backwards compatible with the first version of the database schema;
determining differences between the first version of the database schema and the second version of the database schema;
accessing instructions for responding to the differences between the first version of the database schema and the second version of the database schema; and
subsequent to accessing the instructions for responding to the differences between the first version and the second version of the database schema, executing the ETL solution to generate the third dataset having the target schema, wherein executing the ETL solution comprises one of:
a. applying the instructions for responding to the differences between the first version of the database schema and the second version the database schema to the first dataset; or
b. generating the second dataset using the instructions for responding to the differences between the first version of the database schema and the second version of the database schema, and
applying the ETL solution to the second dataset;
wherein the method is performed by at least one device including a hardware processor.

10. The method of claim 9, further comprising:
executing an operation using the third dataset.

11. The method of claim 9, wherein determining the differences between the first version of the database schema and the second version of the database schema comprises:
accessing a first set of metadata representing the first version of the database schema;
accessing a second set of metadata representing the second version of the database schema; and
comparing the first set of metadata and the second set of metadata to identify one or more differences between the first dataset and the second dataset.

12. The method of claim 9, wherein determining the differences between the first version of the database schema and the second version of the database schema comprises at least one of:
i. identifying one or more columns in the second version of the database schema that is missing in the first version of the database schema;
ii. identifying one or more tables in the second version of the database schema that is missing in the first version of the database schema; or
iii. identifying one or more column types in the second version of the database schema that are different from one or more column types in the first version of the database schema.

13. The method of claim 9, wherein the instructions for responding to the differences between the first version of the database schema and the second version of the database schema comprises at least one of:
i. instructions for creating one or more missing columns;
ii. instructions for creating one or more missing tables; or
iii. instructions for changing a column type.

14. The method of claim 9, wherein determining the differences between the first version of the database schema and the second version of the database schema comprises:
querying the first dataset for a column or a table;
receiving an error message in response to querying the first dataset for the column or the table; and
responsive to receiving the error message, identifying the column or the table as a missing column or table.

15. The method of claim 9, wherein the target schema is amended to hide missing data.

16. The method of claim 9, wherein accessing instructions for responding to the differences between the first version of the database schema and the second version of the database schema comprises:
checking a manifest for default behaviors for responding to the differences; and
generating the instructions for responding to the differences.

17. A system comprising:
one or more hardware processors;
one or more non-transitory computer-readable media; and
program instructions stored on the one or more non-transitory computer-readable media which, when executed by the one or more hardware processors, cause the system to perform operations comprising:
accessing, from an operational database, a first dataset having a first version of a database schema;
accessing an ETL solution for transforming a second dataset having a second version of the database schema into third dataset having a target schema, wherein the second version of the database schema is backwards compatible with the first version of the database schema;
determining differences between the first version of the database schema and the second version of the database schema;
accessing instructions for responding to the differences between the first version of the database schema and the second version of the database schema; and
subsequent to accessing the instructions for responding to the differences between the first version and the second version of the database schema, executing the ETL solution to generate the third dataset having the target schema, wherein executing the ETL solution comprises one of:
a. applying the instructions for responding to the differences between the first version of the database schema and the second version the database schema to the first dataset; or
b. i. generating the second dataset using the instructions for responding to the differences between the first version of the database schema and the second version of the database schema, and
ii. applying the ETL solution to the second dataset.

18. The system of claim 17, wherein the operations further comprise: executing an operation using the third dataset.

19. The system of claim 17, wherein determining the differences between the first version of the database schema and the second version of the database schema comprises:
accessing a first set of metadata representing the first version of the database schema;
accessing a second set of metadata representing the second version of the database schema; and
comparing the first set of metadata and the second set of metadata to identify one or more differences between the first dataset and the second dataset.

20. The system of claim 17, wherein determining the differences between the first version of the database schema and the second version of the database schema comprises at least one of:
i. identifying one or more columns in the second version of the database schema that is missing in the first version of the database schema;
ii. identifying one or more tables in the second version of the database schema that is missing in the first version of the database schema; or
iii. identifying one or more column types in the second version of the database schema that are different from one or more column types in the first version of the database schema.

21. The one or more non-transitory computer readable media of claim 1, wherein the second version of the database schema includes one or more columns, tables, or column types absent in the first version of the database schema, while preserving columns, tables, and column types of the first version.

22. The one or more non-transitory computer readable media of claim 1, wherein the database schema includes a normalized structure and the target schema includes a denormalized structure.
